(19) United States
(12) Patent Application Publication
(10) Pub. No.: US 2011/0105635 A1
(43) Pub. Date: May 5, 2011

(54) POLYURETHANE FOAM FOR USE IN MEDICAL IMPLANTS

(75) Inventors: Folkert Van Beijma, Groningen (NL); Jacqueline De Groot, Groningen (NL)

(73) Assignee: ORTEQ B.V., Groningen (NL)

(21) Appl. No.: 12/993,774

(22) PCT Filed: May 19, 2009
(86) PCT No.: PCT/IB2009/005958

§ 371 Date: Jan. 3, 2011

Related U.S. Application Data
(60) Provisional application No. 61/128,209, filed on May 19, 2008.

(51) Int. Cl. C08G 18/02; C08G 18/10; C08J 9/26

(52) U.S. Cl. 521/155; 528/85; 264/49

(57) ABSTRACT

The present invention provides a polyurethane implant that is porous and degradable, and act as a scaffold for the repair of damaged tissue. Importantly, the implant of the present invention is biocompatible with the degradation products of the implant causing minimal immune or cytotoxic reaction. The present invention also provides for a method of making these biocompatible implants.

### CROSS REFERENCE TO RELATED APPLICATIONS

The present invention claims the benefit of the following U.S. Provisional Patent Application Nos:. 61/128,209, filed May 19, 2008. The contents of this application is incorporated herein by reference.

### FIELD OF THE INVENTION

The invention relates to biocompatible medical implants made from high molecular weight polyurethane foams.

### BACKGROUND OF THE INVENTION

Segmented polyurethane elastomers, which are block copolymers consisting of alternating hard (glassy or semi crystalline) and soft (elastomeric) chain segments, have unique physical and mechanical properties and are known to be biocompatible and blood compatible, due to their hard-segment-soft-segment microphase structure (M. D. Lelah and S L Cooper. Polyurethanes in medicine, CRC Press, Boca Raton, Fla., 1986). For these reasons they are used for a number of biomedical applications.

It is known that aromatic polyurethanes possess better mechanical properties than aliphatic polyurethanes. For many biomedical applications, especially in orthopedic applications, like bone replacement, meniscal reconstruction, or spinal disc replacement, good mechanical properties are required because the forces that orthopedic implants undergo are tremendous. For meniscal reconstruction and meniscal replacement with a degradable porous scaffold, the tear strength of the polymer has found to be important for suturing the implant in place and for the stability of the implant until ingrowth of tissue is complete (De Groot et al. Polymer Bulletin, 1997, 38, 211-218).

The use of aromatic polyurethanes for biomedical applications, especially for applications where degradation of the polymer is required, is undesired. It has been shown that polyurethanes release diamines, which originate from the diisocyanate component in the polymer. The diamines that are released upon degradation for commonly used 4,4′-diphenylmethane diisocyanate and toluene diisocyanate based polyurethanes are 4,4′-diaminodiphenylmethane and toluene diamine, respectively, which are known to be very toxic and carcinogenic (M. Szycher. J. Biomaterial Applications, 1988, 3, 297-402).

De Groot et al. (Polymer Bulletin, 1997, 38, 211-218) used a putrescine based diisocyanate, 1,4-butane diisocyanate, for the preparation of poly(ε-caprolactone) based urethane ureas with excellent mechanical properties, such as a extremely high tear strength. The polyurethanes ureas were made by end capping a poly(ε-caprolactone) macrodiol with a large excess of 1,4-butane diisocyanate to provide a suitable macrodiisocyanate. After this reaction, the excess diisocyanate was removed and the macrodiisocyanate was chain extended with 1,4-butanediamine.

It is known that polyurethane ureas possess better mechanical properties than polyurethanes, due to the higher melting temperature. This is due to a better packing of the hard segments as a result of bifurcated hydrogen bonding (L. Born et al. Colloid and Polymer Science, 1985, 263, 355). That is the reason why polyurethane ureas are more difficult to process compared to polyurethanes. In addition, polyurethane ureas are more difficult to produce compared to polyurethanes. Due to the high reactivity between diisocyanates and diamines, large amounts of solvents are needed.

C. J. Spaans et al. (Polymer Bulletin, 41, 131-138, 1998) described that polyurethane urea with poly(ε-caprolactone) soft segments and butane diisocyanate/butanediamine hard segments shows a high tensile strength, a high modulus and a high resistance to tearing. However, the polymer processing proved to be difficult. When instead of a diamine in the chain extension step a diol (1,4-butanediol) was used, a processable polyurethane was obtained but the tear and tensile strengths were far less. Even polyurethanes with longer hard segments had a lower tear strength than the polyurethane ureas. (C. J. Spaans, Biomedical Polyurethanes Based On 1,4-Butanediisocyanate: An Exploratory Study. 2000 PhD Thesis ISBN 90-367-1232-7, chapter 3).

The mechanical properties are especially preferred when the polymers are intended for use in implants. To this end, the polymers are e.g. processed into porous scaffolds used for, for example, tissue engineering, bone replacement, meniscal reconstruction and meniscal replacement.

Spaans et al. attempted to enhance the mechanical properties of the polyurethanes by synthesizing polyurethanes with longer hard segments. A chain extender was synthesized from 1,4-butane diisocyanate (BDI) and 1,4-butanediol (BDO) first, and the resulting BDO.BDI.BDO chain extender was subsequently reacted with the macrodiisocyanate (C. J. Spaans et al., Polymer Bulletin, 41, 131-138, 1998). This method with the BDO.BDI.BDO chain extender is also described in WO9964491, wherein a method for the production of polyurethanes based on co-polyesters of caprolactone and L-lactide is described. The BDO.BDI.BDO or BDI.BDO.BDI.BDO.BDI blocks described in WO9964491 were used as chain extenders for a macrodiisocyanate or macrodiol respectively. When the latter block was used, good results were obtained. However, the synthesis of these longer chain extenders complicates the production method.

A need therefore still existed for segmented polyurethane elastomers that are easy to synthesize, have good mechanical properties and can be processed into, for example, porous scaffolds (foams) for use as implants.

The synthesis of polyurethanes is in the state of the art usually carried out in the presence of a catalyst, such as stannous octoate, dibutyl stannous dilaureate and/or tertiary amines, such as diazabicyclooctane.

A process for the preparation of catalyst free polyurethanes is also described in U.S. Pat. No. 5,374,704. In this process macrodiols such as Desmophen 2000 are reacted with a (cyclo)aliphatic diisocyanate and chain extended with a (cyclo)aliphatic diol. The process is a conventional two-step process wherein the pre-polymer is first reacted with the diisocyanate, and subsequently chain extended with the diol. When an excess diisocyanate was used, the excess was not removed. In the chain extent step a larger amount of chain extender was used resulting in larger hard segment. These hard segments are not uniform, which is related to the synthesis process. The minimum temperature required for the chain extension step in the process described in U.S. Pat. No. 5,374,704 is 100° C. Mechanical properties of the resulting polymers described in U.S. Pat. No. 5,374,704 were not tested and were not compared to prior art polymers that were synthesized with a catalyst.

Spaans (C. J. Spaans, Biomedical Polyurethanes Based On: 1,4-Butanediisocyanate: An Exploratory Study. 2000 PhD Thesis ISBN 90-367-1232-7, chapter 2) synthesized polyurethane ureas from a macrodiol (poly ε-caprolactone), a diisocyanate(butane diisocyanate) and a diamine (1,4 butanediamine).

Spaans compared two different methods for the synthesis of the polyurethane ureas. In a first method, the macrodiol was reacted with 2 equivalent diisocyanate, and subsequently chain extended with a diamine. In a second method, the macrodiol was reacted with an excess of diisocyanate to ensure the formation of a diisocyanate end capped diol. The excess of diisocyanate was used to ensure the reaction of each macrodiol with two molecules of diisocyanate (and to prevent the formation of macrodiol dimers, trimers etc linked by isocyanate groups). The excess of diisocyanate was removed prior to chain extension with the diamine. The excess of diisocyanate was removed prior to chain extension to prevent the formation of multimers of the chain extender (linked by diisocyanate groups). By this second method, a small size distribution of hard segments formed in the chain extension step is obtained, resulting in improved mechanical properties, compared to the polyurethanes obtained in the first method (or the method disclosed in U.S. Pat. No. 5,374,704, where a narrow size distribution of hard segments cannot be ensured).

For the second method of Spaans, it is essential that all intermediate reaction steps go to completion, i.e. that all —OH groups on the macrodiol molecules are end capped, especially since the unreacted diisocyanate is removed from the reaction mixture afterwards. Any remaining unreacted —OH group on a macrodiol molecule, will prevent the subsequent formation of a polyurethane in the chain extension step.

In contrast, in the first method of Spaans (and U.S. Pat. No. 5,374,704) unreacted diisocyanate remains in the reaction mixture and may still react with any remaining —H groups during the chain extension step.

With respect to the preparations of porous scaffolds, several techniques are known in the art. Gogolewski and Pennings (Makro. Rapid Com. 1982, 3, 839; Makro. Rapid corn. 1983, 4, 213) used a dipcoat technique, in which a polymer solution is mixed with particulate material. A mandrel is dipped in the polymer solution/particulate, after which the coated mandrel was dipped in a non-solvent for the polymer, which resulted in precipitation of the polymer. Subsequently, the particulate material was washed out. In order to produce porous scaffolds with a reasonable thickness (>1 mm), the method has to be repeated several times, which is a disadvantage.

The preparation of thick porous scaffolds is possible using particulate leaching (e.g. De Groot and Pennings et al., Colloid and Polymer Science, 1990, 268, 1073). The essence to create an open-interconnected-pore structure with this technique is that the particles of the pore forming material have to make contact with each other. This technique has disadvantages. In order to obtain an open interconnected pore structure, large amounts of leaching material are required. This results in high porosity materials with no strength and compression modulus. In addition, it has found to be difficult to leach out all the particulate. The remaining salts in the scaffold can cause cell damage.

Another technique has been described by Aubert et al. to produce low density foams (J. H. Aubert and Clough. Polymer, 1985, 26 2047-2054). Polymer solutions are frozen, after which the solvent is removed by sublimation (freeze-drying). The technique of freeze drying for the removal of the solvent, in stead of precipitation (e.g. Gogolewski and Penning, see above), enables the preparation of thick porous scaffolds. The solid solvent keeps the polymer structure fixated during solvent removal. The morphology of the pores, depends on the phase diagram of the polymer in the particular solvent and the freezing point of the solvent. Pore sizes up to 20 μm are reported, which are too small for tissue engineering applications.

The same technique has also been described as a method to produce biomedical porous polymers (Y. S. Nam and T. G. Park. Biomaterials, 1999; 20, 1783-1790). The resulting porous structures had either pores that were too small (below 30 micrometer) for biomedical applications or were poorly interconnected (interconnection between pores was less than 30 μm).

De Groot et al. (Colloid and Polymer Science, 1990, 268, 1073-1081) combined freeze-drying and particulate leaching. A polymer solution, mixed with particulate material, was frozen. The solvent was removed by sublimation and the NaCl crystals were washed out. The pore structure contained large pores (100-300 μm) due to leaching out of the NaCl crystals and small channel-like pores with diameter<50 μm due to crystallization of the solvent. This technique enables the formation of pores with a specific size. Interconnectivity of the pores is obtained by sublimation of the solvent. By sublimation of the solvent, the polymer structure is stabilized during solvent removal.

A disadvantage of freeze-drying polymer solutions is that it requires solubility of the polymer in solvent that can be freeze-dried. 1,4-Dioxane is the most frequently used solvent to prepare porous materials for tissue engineering. For polymers that are not soluble in the solvents which are applicable for freeze-drying, this technique cannot be used.

A method that does not require solubility in solvents that can be freeze-dried is described in WO9925391. A polymer solution was mixed with particulate material. Then the temperature of the mixture was decreased and after that the mixture was poured into a fluid of a certain temperature that is non-solvent for the polymer and a solvent for the particulate material. A great disadvantage of this method is that the structure is formed during washing and, therefore, the porous structure is not easy to control.

When meniscus implants are used, it is preferred that these implants have a high porosity with a high interconnectivity, in order to get a good ingrowth of new tissues, and a high (tear) strength and a high compression modulus to deal with the forces that the implant experiences. It is also preferred that the scaffold is biodegradable and that when it degrades, the degradation products are biocompatible.

### SUMMARY OF THE INVENTION

In one embodiment the present invention provides a polyurethane prepared by a process comprising:
(a) reacting a diol, preferably a C₁-C₁₀ alkyl diol, more preferably 1,4-butanediol, with an oxygen containing compound that can form a macrodiol by ring-opening polymerization, preferably a lactone, more preferably ε-caprolactone, to provide a macrodiol, wherein the reaction is carried out to completion, preferably until the unreacted remaining oxygen containing compound that can form a macrodiol by ring-opening polymerization is less than 0.5% by mole equivalents of the total amount of the oxygen containing compound, more preferably less than about 0.2% by mole equivalents;
(b) treating the macrodiol with a diisocyanate, to obtain a macrodiisocyanate, wherein the unreacted diisocyanate is removed under a pressure of less than about 0.01 mbar, preferably less than about 0.003 mbar, preferably until the remaining amount of unreacted diisocyanate is between −5% to 5% by mole equivalent, of the calculated required amount of diisocyanate in the reaction, more preferably between −2% and 2% by mole equivalents, even more preferably between −1% and 1% by mole equivalent; most preferably between −0.5% and 0.5% by mole equivalents; and
(c) reacting the macrodiisocyanate with a diol chain extender, preferably a diol, more preferably a C₁-C₁₀ alkyl diol, even more preferably 1,4-butanediol, wherein the molar ratio of macrodiisocyanate:diol is 1.00:1.00 to 1.00:1.09, preferably 1.00:1.01 to 1.00:1.03.

In another embodiment of the present invention there is provided a foam comprising polyurethane having average molecular weight of about 110 kg/mol to about 240 kg/mol, a compression module of about 50 kPa to about 1500 kPa, and a tear strength of greater than 3 N/mm. Preferably, the foam has a flexibility of 100% or more, more preferably of 100% to about 500%, even more preferably of about 300% to about 400%. Preferably, the density of the foam is from about 0.1 to about 0.4 g/cm³, more preferably about 0.22±0.04 g/cm³.

In another embodiment, the polyurethane polymer in the foam of the present invention has an average molecular weight of about 110 kg/mol to about 240 kg/mol.

In another embodiment, the foam of the present invention has a compression modulus between about 50 kPa to about 1500 kPa.

In another embodiment, the foam of the present invention has a tear strength of about 3 N/mm or greater.

In yet another embodiment, the foam of the present invention has a flexibility (strain at break) of about 100% or higher.

In another embodiment, the foam of the present invention has a density of about 0.22±0.04 g/cm³.

In another embodiment of the present invention there is provided a foam prepared by a process comprising:
(a) preparing a solution of about 20% to about 50% (w/v), preferably of about 30% to about 45% (w/v), preferably about 36% (w/v) of polyurethane, as prepared according to the process of the present invention in an appropriate solvent, preferably wherein the polyurethane is soluble, preferably DMSO, DMF, chloroform, 1,4-dioxane, NMP, m-cresol, dimethyl acetamide, more preferably DMSO.
(b) combining the solution with a non-solvent, preferably water or a C₁-C₆ alkyl diol, more preferably water, to obtain a solution, preferably the amount of non-solvent added to the solution is in an amount from 5% to 30% (v/v), more preferably 5% to 20%, most preferably from 5% to 10% (v/v).
(c) adding a pore forming material not soluble in the solvent, preferably a salt, more preferably an alkali metal or alkaline earth metal salt, even more preferably an halogen salt of an alkali metal or alkaline earth metal, most preferably NaCl, to obtain a viscous mixture;
(d) pouring the viscous mixture into a mold and cooling, in any order to obtain a molded material; and
(e) washing the molded material with a non-solvent wherein the polyurethane polymer is insoluble but wherein the pore forming material can be dissolved to obtain a foam.

In another embodiment the present invention provides a process for preparing a polyurethane comprising the steps of:
(a) reacting a diol, preferably a C₁-C₁₀ alkyl diol, more preferably 1,4-butanediol, with an oxygen containing compound that can form a macrodiol by ring-opening polymerization, preferably a lactone, more preferably ε-caprolactone, to provide a macrodiol, wherein the reaction is carried out to completion, preferably until the unreacted remaining oxygen containing compound that can form a macrodiol by ring-opening polymerization is less than 0.5% by mole equivalents of the total amount of the oxygen containing compound, more preferably less than about 0.2% by mole equivalents;
(b) treating the macrodiol with a diisocyanate, to obtain a macrodiisocyanate, wherein the unreacted diisocyanate is removed under a pressure of less than about 0.01 mbar, preferably less than about 0.003 mbar, preferably until the remaining amount of unreacted diisocyanate is between −5% to 5% by mole equivalent of the calculated required amount of diisocyanate in the reaction, more preferably between −2% and 2% by mole equivalents, even more preferably between −1% and 1% by mole equivalent; most preferably between −0.5% and 0.5% by mole equivalents; and
(c) reacting the macrodiisocyanate with a diol chain extender, preferably a diol, more preferably a C₁-C₁₀ alkyl diol, even more preferably 1,4-butanediol, wherein the molar ratio of macrodiisocyanate:diol is 1.00:1.00 to 1.00:1.09, preferably 1.00:1.01 to 1.00:1.03.

In another embodiment, the present invention provides a process for preparing a foam comprising the steps of:
(a) Preparing a solution of about 20% to about 50% (w/v), preferably of about 30% to about 45% (w/v), preferably about 36% (w/v) of polyurethane, as prepared according to the process of the present invention in an appropriate solvent, preferably wherein the polyurethane is soluble, preferably DMSO, DMF, chloroform, 1,4-dioxane, NMP, m-cresol, dimethyl acetamide, more preferably DMSO.
(b) combining the solution with a non-solvent, preferably water or a C₁-C₆ alkyl diol, more preferably water, to obtain a solution, preferably the amount of non-solvent added to the solution is in an amount from 5% to 30% (v/v), more preferably from 5% to 20%, most preferably from 5% to 10%;
(c) adding a pore forming material not soluble in the solvent, preferably a salt, more preferably an alkali metal or alkaline earth metal salt, even more preferably an halogen salt of an alkali metal or alkaline earth metal, most preferably NaCl, to obtain a viscous mixture;
(d) pouring the viscous mixture into a mold and/or cooling, in any order to obtain a molded material; and
(e) washing the molded material with a non-solvent wherein the polyurethane polymer is insoluble but wherein the pore forming material can be dissolved to obtain a foam; and

One of the embodiments of the present invention provides biocompatible medical implants made from the polyurethane foams of the present invention. In one embodiment, the biocompatible medical implants degrade after implantation and the degradation products are biocompatible. In one embodiment, the medical device is a meniscal implant. In another embodiment, the medical device is a glenoid and glenoid labrum implant.

### BRIEF DESCRIPTION OF THE FIGURES

FIG. 1 shows stress strain curves of tear tests as a function of molecular weight. Top: Mn=120 kg/mol. Middle: Mn=100 kg/mol. Bottom: Mn=56 kg/mol.

FIG. 2 shows a polyurethane and its synthesis using an isocyanate-terminated prepolymer.

FIG. 3 shows tear strength as a function of molecular weight of the foams.

FIG. 4 shows an example of a phase diagram of a polymer solution.

FIG. 5 shows test set up for determination of tear strength of the foam.

FIG. 6 shows the in-vitro degradation study on a sample implant. Change in Mn as a function of exposure time.

FIG. 7 shows the correct positioning of dynamic MR image for meniscal implant analysis showing (a) transverse and (b) perpendicular views of the meniscal implant.

FIG. 8 shows a microscopic biopsy image; inner rim (most far away from the peripheral rim) of the implanted device at 12 months showing maturing tissue with fibrochondrocytic differentiation and organised collagen bundles.

FIG. 9. Synovial tissue showing a macrophage (asterix) driven inflammation with swollen intima (short arrow). Some implant particles can be noted in the interstitium (long arrow) as well as phagocytosed by these macrophages (arrow head).

FIG. 10 shows a representative contrast MR images showing (a) scan and TIC with signal enhancement, and (b) scan and TIC with no signal enhancement. The TIC for the region of interest [peripheral zone of the meniscus device in (a) and central half of the meniscus device in (b)] is indicated by the red line on the chart.

FIG. 11 shows an anatomic MRI showing the implanted scaffold meniscus.

### DETAILED DESCRIPTION OF THE INVENTION

The foams of the present invention and the medical devices made therefrom are degradable and biocompatible and have properties that make the devices especially useful including modulus of compression between about 50 kPa to about 1500 kPa, preferably about 250 kPa to about 400 kPa, a tear strength of greater than or equal to about 3 N/mm, and flexibility (strain at break) of about 100% or higher. These advantageous properties are in part due to the high molecular weight of the polymers in the foam and the in part due to the interconnectivity of the polymers in the foam. This high molecular weight and interconnectivity are achieved by the process of making the polyurethane polymer and by the process of making the foam from the polyurethane polymer. The final average molecular weight of the polymer in the foam is about 110 kg/mol to about 240 kg/mol. Preferably the average molecular weight of the polymer is about 120 kg/mol to about 240 kg/mol. More preferably, the average molecular weight of the polymer in the foam is 140 kg/mol to about 240 kg/mol.

The tear strength of greater than or equal to about 3 N/mm and flexibility of about 100% or higher are important parameters because they determine the ease of suturing the implant in place.

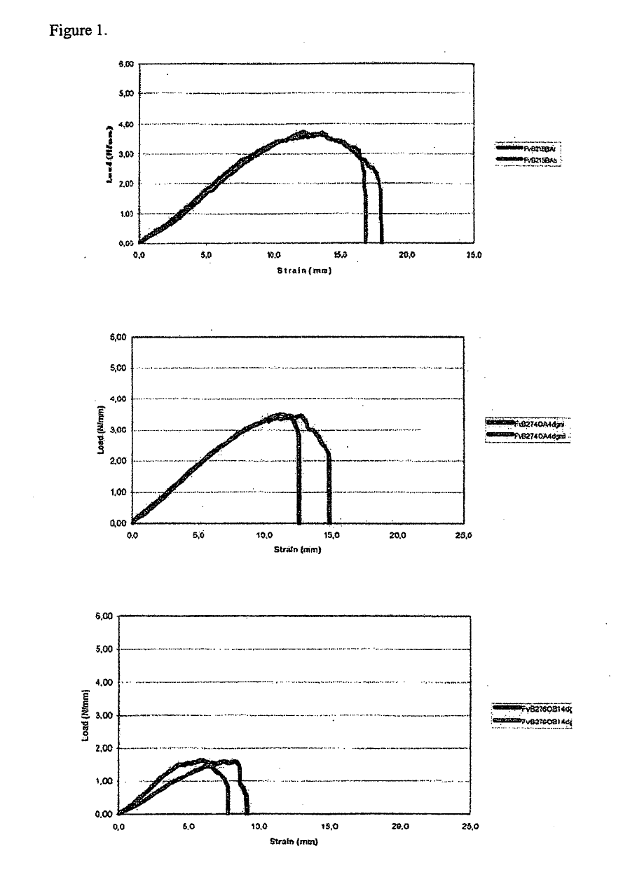

Tear strength and flexibility can be measured on an Instron 5565 fitted with a 100 N load cell with the crosshead speed set to 10 mm/min and the data collection rate was set to 10 pts/second. FIG. 1 shows the shows stress strain curves of tear tests as a function of molecular weight of the foams. The samples were taken from cylindrically-shaped polyurethane foams by cutting away the top and bottom of each cylinder using a razorblade and by horizontally halving the remaining foam to create two circular pieces of ca. 12 mm thickness. These were subsequently halved vertically to give two semicircular pieces. These semicircular pieces were halved vertically to give two quarter parts. The tear strength samples were created by halving the quarter parts horizontally using a razorblade to give two wedges. Each wedge was measured using a marking gauge to determine the thickness. Using a needle of ca. 0.7 mm thickness, two 2-0 MERSILENE® braided polyester sutures were placed at 3 mm from the curved edge of each wedge to enable a duplicate measurement (i and ii) for each sample. Tear tests were performed with the pointed end of each wedge placed in the lower clamp and the two ends of one suture placed in the upper clamp. For each sample a Load/Strain curve was calculated from the raw data by plotting the Load (N) corrected for the sample thickness (mm) against the crosshead extension (mm). The mean maximal load (N) over sample thickness (mm) over four measurements was taken as a value for the tear strength of each (N/mm) of each foam.

The flexibility was calculated as follows: the displacement at break divided by the distance of the suture to the edge of the implant material (being defined as 3 mm in this test method)*100%.

The compression tests were performed on an Instron 5565 fitted with a 100 N load cell. The crosshead speed was set to 2 min/min and the maximum load to 80 N. The data collection rate was set to 20 pts/second. The samples for the compression tests were created by vertically halving the semicircular pieces of polyurethane foam using a razorblade to give two quarter parts. Each wedge was measured using a marking gauge to determine the thickness and two radiuses. The area (A) of each foam wedge was calculated from the two radiuses using the following formula:

A=(π*r1*r2)/4

In which:
A=sample area (mm²)
r1=radius no. 1 (mm)
r2=radius no. 2 (mm)

For each sample a Load/Strain curve was calculated from the raw data by plotting the Load (N) against the percentage of Strain (%) derived from the sample thickness (mm) and the amount of compression (mm). The samples were compressed two times to a maximum of 60 N. It appeared that a small difference was observed between the first and second cycle and that no difference was observed between second, third and fourth cycle. Therefore, from the second cycle the compression data were calculated. Compression modulus (C) was calculated from the raw data. In order to obtain the most uniform results, the compression modulus'of the various samples was determined at the point in the Load/Strain curve where the development of the slope coefficient was most constant. For the reference samples this point was determined by calculating the slope coefficient at each point in the Load/Strain curve using the 25 preceding data points and the 25 following data points and by subsequently calculating the slope coefficient over these values according to the same method. The last negative value in the 10-30% Strain area of this last series of data with a positive preceding value (or vice versa) was taken as the point to calculate the compression modulus for a particular sample.

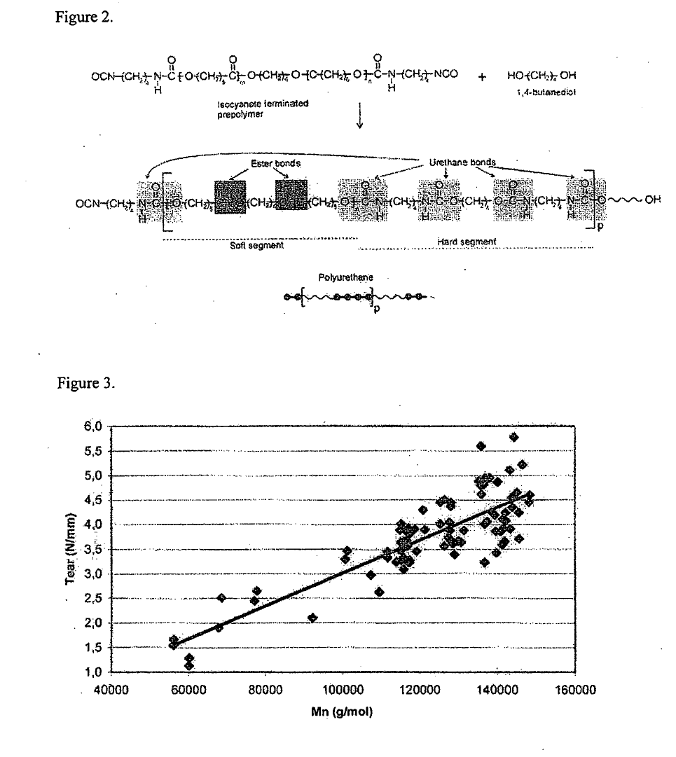

The polyurethane contains two types of bonds that are susceptible to hydrolysis: ester bonds and urethane bonds (FIG. 2). Urethane bonds are more resistant to hydrolytic cleavage than ester bonds and that crystaline parts of the polymer are more resistant to hydrolytic cleavage than amorphous parts of the polymer. It is therefore expected that hydrolytic cleavage of the poly(ε-caprolactone) ester bonds will occur first in vivo.

Since ingrowth of tissue in the implant is expected to be complete after 3-4 months it is desired that the implant maintains its mechanical properties for at least 3 months. After implantation, the molecular weight of the polyurethane is decreasing as a result of hydrolysis of the polymer in the body. It is preferred for the functionality of the polyurethane implants of the present invention that the foam maintains its mechanical properties for at least three months. Among the properties described above the tear strength dependence on the molecular weight is most critical. Above a molecular weight of 100 kg/mol the tear strength is ≧3 N/mm (FIG. 3).

Therefore, after 3 months of implantation the polymer of the foam should have molecular weight of greater than or equal to 100 kg/mol. Degradation in vivo is believed to be dominated by hydrolysis and, therefore, comparable to in-vitro degradation at 37° C. According to FIG. 6, four months of degradation causes a molecular weight decrease of about 7 kg/mol. Therefore the foam should have an average molecular weight greater than about 110 kg/mol in order for the implant to retain the desired physical characteristics after being implanted for three months. Preferably, the foam should have an average molecular weight of greater than about 120 kg/mol. More preferably, the average molecular weight of the polymer in the foam greater than about 140 kg/mol.

The term biocompatible means that the implant of the present invention as well as wear debris and the materials generated during in vivo degradation do not cause a substantial immune response, sensitation, irritation, cytotoxicity or genotoxicity.

According to this invention, a macrodiol is to be understood as a polymer having terminal hydroxy groups, wherein the macrodiol preferably has a (number average) molecular weight of about 600 to about 3000 g/mol. Suitable examples and preferred embodiments of the macrodiol are given below.

The macrodiol prepared in the method according to the invention may be a polyester or copolyesters made by ring-opening polymerization of cyclic reactants, based on, for example, e-caprolactone, lactide, glycolide, delta-valerolactone, 1,4-dioxane-2-one, 1,5-dioxepan-2-one, oxepan-2,7-dione; polycarbonates and copolycarbonates based on, for example 1,6-hexanediol polycarbonate; polycarbonates and copolycarbonates made by ring-opening polymerization based on, for example, trimethylenecarbonate(1,3-dioxane-2-one), tetramethylenecarbonate, 1,3-dioxepan-2-one or 1,3,8,10-tetraoxacyclotetradecane; polymers and copolymers based on combinations of above described components; polymers made ring-opening polymerization are preferred.

Preferred macrodiols are the ones that are made by ring opening polymerization of oxygen containing compounds. A particularly preferred macrodiol may is poly(ε-caprolactone)diol, which is prepared by the ring-opening polymerization of ε-caprolactone. Preferably, a poly(ε-caprolactone) with a molecular weight between 600 and 3000 g/mol, more preferably between 1000-2200 g/mol, is used.

The reaction to form the macrodiol can be carried out in accordance with procedures which are known in polyurethane chemistry. Macrodiols made by ring opening polymerization are normally synthesized in the presence of a catalyst (e.g. stannous octoate, dibutyl stannous laurate). With the method of the invention, preferably the macrodiol is synthesized catalyst-free. The advantage of such a method is that the catalyst does not need to be removed after the macrodiol is synthesized. Thus, for example, a macrodiol such as poly(ε-caprolactone), which is produced by ring opening polymerization, is preferably produced in a catalyst-free method, when it is used in the method of the invention.

In particular, the present invention provides a process preparing the macrodiol by reacting a diol, preferably a C₁-C₁₀ alkyl diol, more preferably 1,4-butanediol, with an oxygen containing compound that can form a macrodiol by ring-opening polymerization, preferably a lactone, more preferably ε-caprolactone, to provide a macrodiol, wherein the reaction is carried out to completion. Preferably the reaction is continued until the unreacted remaining oxygen containing compound that can form a macrodiol by ring-opening polymerization is less than 0.5% by mole equivalents of the total amount of the oxygen containing compound, more preferably less than about 0.2% by mole equivalents.

In one embodiment, the macrodiol has a molecular weight between 1000 and 3000 g/mol, e.g. between 1200-2600 g/mol. For e.g. meniscus implants, scaffolds based on macrodiols having a molecular weight preferably between 1400 and 2200 g/mol, like e.g. 1500-1700 g/mol gave good results.

According to this invention, a diisocyanate is to be understood as a compound having the formula OCN—R—OCN, wherein R is a C₂-C₁₄ aliphatic or cycloaliphatic radical, preferably a C₂-C₁₄ alkylene or cycloalkylene radical. If R is an aliphatic radical, it is preferred that the OCN-groups are terminal groups. The aliphatic radicals may be linear or branched and are preferably linear. More preferably, R is a C₃-C₁₂ aliphatic or cycloaliphatic radical, and even more preferably, R is a C₃ to C₆ alkylene. Suitable examples and preferred embodiments of the diisocyanates are given below.

In the production of polyurethanes many different diisocyanates, both aromatic and aliphatic, have been used. However, when the resulting polyurethanes are intended for use in biomedical applications aliphatic or cycloaliphatic diisocyanates are preferred. Aliphatic diisocyanates for use in the method of the invention include, for example, the known aliphatic and cycloaliphatic diisocyanates such as, for example 4,4′-dicyclohexanemethane (H12MDI or reduced MDI), 1,4-transcyclohexane-diisocyanate (CHDI), isophorone diisocyanate (IPDI), 1,6-hexane diisocyanate (HDI) or 1,4-butane diisocyanate (BDI).

According to this invention, a chain extender is to be understood as a compound having the formula Y—R—Y, wherein R is a C₂-C₁₄ aliphatic or cycloaliphatic radical. Preferably a C₂-C₁₄ alkylene or cycloalkylene radical, and wherein Y represents OH, NH₂ or NHR′, wherein R′ is a C₁-C₁₂ aliphatic radical, preferably an alkyl radical. If R is an aliphatic radical, it is preferred that the Y groups are terminal groups. The aliphatic radicals may be linear or branched and are preferably linear. More preferably, R is a C₃-C₁₂ aliphatic or cycloaliphatic radical, and even more preferably R is a C₃ to C₆ alkylene. Most preferably, Y is OH. Thus, in particularly preferred embodiments, the chain extender is a diol of the formula HO—R—OH. Suitable examples and preferred embodiments of the chain extender are given below.

Suitable chain extenders include diol and diamine compounds. Suitable diamines include aliphatic diamines including ethylene-; propylene-, butane-, and hexamethylenediamines; cycloaliphatic diamines, such as, for example 1,4-isophorone diamine and 1,4-cyclohexane diamine. Another example of a suitable diamine is 1,4-butanediamine. Hence, the invention is also directed to a method wherein the chain extender comprises a diamine. The diamines can e.g. be selected from the group consisting of ethylene-, propylene-, butane-, hexamethylene-diamines, like 1,2-ethylene diamine, 1,6-hexamethylene diamine etc., 1,4-isophorone diamine, 1,4-cyclohexane diamine and 1,4-cyclohexane diamine, etc.

The use of a diamine may result in polyurethane ureas with better mechanical properties, compared to polyurethanes based on a diol chain extender. However, it has been found that with the method of the invention polyurethanes can be synthesized with excellent mechanical properties. The mechanical properties of polyurethanes prepared according to the method of the invention are at least comparable to those of state of the art polyurethanes ureas.

The use of a diol as chain extender instead of a diamine has the advantage that the method parameters are easier to control and the produced polyurethane is easier to method. The use of a diol as chain extender in the method of the invention is therefore preferred.

Suitable diols for use as a chain extender in the method of the invention may be (cyclo)aliphatic diols such as for example ethyleneglycol, diethylene glycol, dipropylene glycol, 1,4-butanediol (BDO), 1,6-hexanediol (HDO), 1,8-octanediol, neopentyl glycol, 1,12-dodecanediol, cyclohexanedimethanol, or 1,4-cyclohexanediol.

Preferably, when for example, 1,4-butanediisocyanate (BDI) is used as the diisocyanate, BDO is used as the chain extender.

When BDO was used with the method of the invention, polyurethanes with excellent mechanical properties were obtained. Aliphatic diols such as 1,4-butanediol or 1,6-hexanediol, when used in the method of the invention, already give polyurethanes with good mechanical properties.

In another embodiment of the method of the invention “diol block” chain extenders may be used. Such “diol blocks” have been described by Spaans et al. (Polymer Bulletin, 41, 131-138, 1998). Diol block chain extenders are reaction products of a diisocyanate and an excess of a diol. Such “diol blocks” may be prepared by reacting a diisocyanate and a diol, after which the unreacted excess diol is removed by for instance evaporation or extraction. Such diol blocks may be, for example, the reaction product of 1,4-butane diisocyanate (BDI) and 1,4-butanediol (BDO) or BDI and 1,6-hexanediol (HDO) or 1,6-hexanediisocyanate (HDI) and HDO, resulting in “diol block” chain extenders like BDO.BDI.BDO, or HDO.HDI.HDO. For the method according to the invention, such “diol block” chain extenders are preferably produced in the absence of a catalyst. Such “diol block” chain extender can also comprise more repeating units, like BDO-(BDI-BDO)ₙ, wherein n=0-10, e.g. n=1, 2 or 3.

In one embodiment the present invention provides a method for preparing a polyurethane comprising the steps of:
(a) reacting a diol, preferably a C₁-C₁₀ alkyl diol, more preferably 1,4-butanediol, with an oxygen containing compound that can form a macrodiol by ring-opening polymerization, preferably a lactone, more preferably ε-caprolactone, to provide a macrodiol, wherein the reaction is carried out to completion, preferably until the unreacted remaining oxygen containing compound that can form a macrodiol by ring-opening polymerization is less than 0.5% by mole equivalents of the total amount of the oxygen containing compound, more preferably less than about 0.2% by mole equivalents;
(b) treating the macrodiol with a diisocyanate, to obtain a macrodiisocyanate, wherein the unreacted diisocyanate is removed under a pressure of less than about 0.01 mbar, preferably less than about 0.003 mbar, preferably until the remaining amount of unreacted diisocyanate is between −5% to 5% by mole equivalent of the calculated required amount of diisocyanate in the reaction, more preferably between −2% and 2% by mole equivalents, even more preferably between −1% and 1% by mole equivalent; most preferably between −0.5% and 0.5% by mole equivalents; and
(c) reacting the macrodiisocyanate with a diol chain extender, preferably a diol, more preferably a C₁-C₁₀ alkyl diol, even more preferably 1,4-butanediol, wherein the molar ratio of macrodiisocyanate:diol is 1.00:1.00 to 1.00:1.09, preferably 1.00:1.01 to 1.00:1.03.

Preferably the steps a) and b) are carried out in the substantial absence of a catalyst. With “the substantial absence of a catalyst” is meant a catalyst concentration below 0.001 wt.-% (wt. catalyst/wt. polyurethane), preferably below 0.0001 wt.-% and most preferably no catalyst at all. Hence, in an embodiment, the invention is directed to a method for preparing a polyurethane wherein the catalyst concentration is below 0.001 wt.-% (wt. catalyst/wt. polyurethane).

The reaction temperature in step (a) is preferably about 140° C. to about 170° C., more preferably the reaction temperature is about 150° C. Completion of the reaction step (a) may be monitored by observing the amount of unreacted oxygen containing compound, preferably lactone, for example by using H¹-NMR. Complete conversion is preferred as unreacted oxygen containing compounds such as lactone may be carried into the following end-capping step and interfere with the calculation of the amount of diisocyanate in the end-cap process.

The macrodiol from step (a) is then treated with diisocyanate to provide a macrodiisocyanate. An excess of diisocyanate is typically used to diminish the risk of the formation of macrodiol dimers (two polyols combined with one diisocyanate) and trimers (three macrodiols combined with two diisocyanates). With an excess of diisocyanate is meant a ratio at least above 2:1 (diisocyanate:macrodiol). Preferably the ratio is about 2:1 to about 9:1, for example 6:1. Preferably, step (b), the end-cap step of the macrodiol to obtain a macrodiisocyanate is carried out at a temperature between about 50-120° C., e.g. between about 50-100° C. or preferably between about 50-90° C. In a further preferred embodiment, the temperature is between about 60-85° C. Preferably the treatment in step (b) is carried out for a period of about 3.5 hours to about 8 hours, preferably for about 4 hours to about 6 hours.

Any surplus of diisocyanate in step (b) is preferably removed, for example by distillation at reduced pressure of preferably less than 0.01 mbar and more preferably less than about 0.003 mbar. In one embodiment the distillation may be performed at about 50° C. to about 90° C., in another embodiment the distillation may be performed at about 50° C. to about 90° C. In one embodiment the distillation may be performed at 68° C. The amount diisocyanate that is removed can be determined by weighing or by spectroscopic techniques like NMR and IR. Extraction may also be performed to remove unreacted diisocyanate using for instance a soxlet apparatus. Removal of the unreacted diisocyanate by distillation under reduced pressure is preferred.

The macrodiisocyanate is then reacted with diol, preferably at a temperature of about 85 to about 95° C. It is believed that the use of higher temperature assists in obtaining the higher molecular weight polymers. The amount of diol that has to be added is calculated as macrodiol:diol chain extender. In preferred embodiments, the excess of diol is in the molar ratio of macrodiol:diol of 1.00:1.00 to 1.00:1.09, more preferably 1.00:1.01 to 1.00:1.03. The range of diol excess that is used may be preferred because at lower amounts cross-linking may occur. At higher diol excesses, although the same molecular weight of the bulk polymer may be achieved, the molecular weight does not increase enough in the foam process, perhaps due to sub-optimal stoichiometry.

In one embodiment, step (c), the chain extension step, is carried out at a temperature between about 50-180° C., e.g. between about 50-120° C. or preferably between about 50-100° C. In solution, a higher temperature can be chosen, e.g. 80° C.-150° C., which depends on the concentration. For example, when in the bulk polymerization is performed at 80° C., and results in polymer with sufficient molecular weight, it was found that in solution at a concentration of 50%, at a temperature of 80° C., the resulting polymer had a lower molecular weight. Either the temperature or the concentration of the polymer in the solvent can be raised to obtain good results. These temperatures are especially applicable for the preparation of polyurethanes wherein the chain extender is a diol. When the chain extender is a diamine, and polyurethane ureas, are made, lower temperatures may be used like e.g. room temperature. Preferably, chain extension takes place in the substantial absence of a solvent (bulk). The reaction between the macrodiisocyanate and the chain can also be carried out in a solvent such as dimethylsulfoxide (DMSO), dimethylformamide (DMF), chloroform, 1,4-dioxane, N-methylpyrrolidone (NMP), m-cresol. In that case, when using a solvent, higher minimal temperatures are needed (at least 100° C.), and preferably 120° C. In preferred embodiments, the reaction between the macrodiisocyanate and the chain extender is carried out in the absence of a solvent.

The method of the invention results in polyurethanes that have excellent mechanical properties and can e.g. be processed into foams for use as porous scaffolds in body implants.

Higher intrinsic viscosities of the polyurethane are obtained at longer reaction times. It may be that the intrinsic viscosity of the polymer increases during processing of the polymer (e.g. polymer film or porous polymer) but that does not negatively influence the characteristics. In case the intrinsic viscosity is increasing when processing, the reaction can be ended earlier. An intrinsic viscosity determination is described in any general Polymer Chemistry textbook (e.g. J. M. G. Cowie. Polymers: Chemistry & Physics of modern materials, Second edition, Chapman & Hall, 1991, page 207-209). The mechanical properties as tear strength and tensile strength are a function of the intrinsic viscosity.

In one embodiment, the invention provides a polyurethane prepared according to the process of the invention described above. A polyurethane based on a poly(ε-caprolactone)diol with a molecular weight of approximately 1900-2200 g/mol, 1,4-butanediisocyanate and 1,4-butanediol as a chain extender may also have a tear strength above 90 kJ/m². A polyurethane of the invention based on a poly(ε-caprolactone)diol with a molecular weight of approximately 1500-1700 g/mol, 1,4-butanediisocyanate and 1,4-butanediol as a chain extender, may also have a tear strength above 130 kJ/m². The person skilled in the art understands that the molecular weights are mean molecular weights.

The polyurethane according to the invention is, due to the properties like tensile and tear strengths and the absence of catalyst traces, very suitable for use in biomedical applications. In particular the polyurethane prepared according to the present invention due to the absence of significant amounts of unreacted starting materials or by products formed by unreacted starting materials in the process steps, is suitable for use in preparing a foam (porous scaffold), in particular a biocompatible foam.

In the invention, the term poly urethane also comprises combinations of polyurethanes, e.g. based on macrodiols having different molecular weights, and poly urethane ureas. Likewise, the terms macrodiols, diols, diamines, diisocyanates may comprise combinations of macrodiols, diols diamines or diisocyanates, respectively. Molecular weights of macrodiols are mean molecular weights. Though a number of embodiments describe elastomers, the invention is not limited to elastomers only.

The melting point and the melting enthalpy of the hard segments of the polyurethanes synthesized according to these methods are increased, and the mechanical properties as tensile strength and tear strength of the polyurethanes synthesized are improved, when compared to prior art methods (C. J. Spaans, Biomedical Polyurethanes Based On: 1,4-Butanediisocyanate: An Exploratory Study. 2000 PhD Thesis ISBN 90-367-1232-7, chapter 2) where a catalyst was used, and wherein the catalyst was used in a concentration of about 0.08 wt. % (wt. catalyst/wt. polymer).

The polyurethanes made according to process of the invention have different thermal properties and better mechanical properties than the polyurethanes made according the same process but made with a catalyst. With the method of the invention the chain extension may even be carried out at temperatures as low as 80° C.

Provided the polyurethanes can be processed into foams, they can, for example, be used as porous scaffolds used in tissue engineering, as prosthesis or implants, e.g. meniscus reconstructions or replacements. The advantage of porous implants is that the growth of tissue is possible within the pores. To promote the growth of tissue, the porous scaffolds preferably have an interconnected porous structure that may be created by particulate leaching. The diameter of the interconnection between the pores is preferable more than 30 μm.

In general, foams for use as porous scaffolds in body implants can be made in various ways known in the art, such as freeze-drying/particulate leaching. These techniques usually include a step in which the polymer is dissolved in an appropriate solvent and the addition of a non-solvent (in which the polymer does not dissolve) and the addition of a particulate material, usually a crystalline material such as a salt, as pore former. It is essential that the particulate material does not dissolve in the solvent and non-solvent used. The porosity and the structure of the porous scaffold is determined by the concentration of the polymer in the solution and of the amount and particle size of the particulate material added.

Thus a porous scaffold comprising a polyurethane (prepared by the method) according to the invention is likewise part of the present invention. The porous scaffolds may be used as body implants for, for example, meniscus reconstruction or replacement. Such an implant is therefore likewise part of the present invention.

A preferred method to prepare porous scaffolds (foam) of the present invention includes the method as described in published US Patent Application US 2007/0015894, which is incorporated herein by reference. Specifically, this method provides a controllable and reproducible way of making a porous scaffold from an elastomer that is especially suitable for use with the polyurethanes (produced by the method) according to the invention. However, the method for making a porous scaffold according to the invention may likewise be applied to other elastomers suitable for the desired application. The method of the invention results in a porous scaffold, the porosity of which is determined by the combined effects of particulate leaching and phase separation occurring in a solution of the polymer in an appropriate solvent. Especially for polyurethanes made according to the method of the invention and also for, for example polyurethane ureas, the methods for preparing porous scaffolds of the prior art do not result in an interconnected pore structure that allows ingrowth of cells. When e.g. the technique according to WO9925391 was used for polymers made according to the invention, polymer scaffolds with poorly interconnected pore structures were obtained.

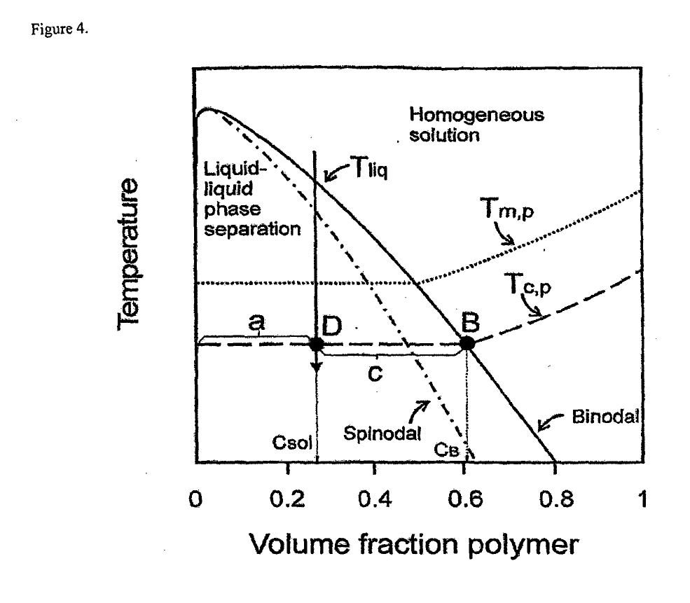

The method for making a porous scaffold according to the invention is based on the finding that a porous scaffold with excellent properties can be obtained when a solution is used wherein, upon cooling down, liquid-liquid phase separation occurs (at a temperature T_{liq}, see FIG. 4), prior to crystallization of either the polymer (at the crystallization temperature, T_{cp}, of the elastomer) or the solvent (or solvent/non-solvent mixture) (at the crystallization temperature, T_{c,s}, of the solvent (or solvent/non-solvent mixture). Because phase separation occurs prior to crystallization, a very good porous structure is obtained that is fixed (stabilized) when either the polymer or the solvent crystallizes.

The method of the invention is especially suitable for use with polymers that crystallize in solution.

The present invention therefore provides for a method for making a porous scaffold from a polymer, comprising the steps of:
a) providing a homogeneous solution of the polymer in a solvent wherein the polymer-solvent combination is chosen in such a way that for the chosen combination liquid-liquid phase separation occurs, upon cooling down, at a temperature (T_{liq}) that is higher than the crystallization temperature of either the polymer (T_{c,p}) or the solvent (T_{c,s}).
b) adding a particulate material that is insoluble in the solvent,
c) cooling down the mixture obtained at b) at a rate that allows liquid-liquid phase separation to result in the desired micropore morphology for the porous scaffold, to a temperature below the crystallization temperature of either the polymer (T_{c,p}) or the solvent (T_{c,s})
d) washing the mixture obtained at c) with a non-solvent, wherein the polymer is insoluble, but wherein the particulate material can be dissolved, at a temperature below the melting temperature of the polymer in solution (T_{m,p}), or at a temperature below the melting temperature of the solvent (T_{m,s}), for a time sufficient to allow dissolution of the particles of the particulate material.

According to the invention, the invention is also directed to a method for making a porous scaffold from a polymer, comprising the steps of:
a) preparing a homogeneous solution of a polymer and a solvent;
b) adding a pore forming material to the homogeneous solution that is not soluble in the solvent to form a homogeneous mixture of the polymer, the solvent and the pore forming material;
c) cooling the homogeneous mixture to a temperature T_{liq} to form a liquid mixture comprising a polymer rich phase and a polymer pore phase, wherein T_{liq} is higher than T_{c,p} and higher than T_{c,s};
d) further cooling the liquid mixture to a temperature below T_{c,p} to form the porous scaffold; and
e) washing the porous scaffold with a non-solvent at a temperature T, wherein the T is lower than T_{m,p} or lower than T_{m,s}.

In a preferred embodiment, especially with respect to applications as meniscus, etc., the polymer that is used comprises an elastomer, or combinations of elastomers. The polymers (in general), or the elastomers, that can be used in the methods for making a porous scaffold according to the invention are those polymers, that can be solved in a solvent.

In a further preferred embodiment, the methods for making a porous scaffold according to the invention are directed to polyurethanes or polyurethane ureas (elastomeric or not), that are obtainable according to the method for preparing a polyurethane according to the invention.

It is preferred that liquid-liquid phase separation occurs before the polymer in solution crystallizes or before the solvent (mixture of solvents and non-solvents) crystallizes. When the temperature at which the polymer in solution crystallizes is higher than the crystallization temperature of the solvent, it is preferred that T_{liq}>T_{c,p}. When the temperature at which the polymer in solution crystallizes is lower than the crystallization temperature of the solvent, it is preferred that T_{liq}>T_{c,s}. This is because at either T_{c,p} or T_{c,s} the structure is fixed and that upon washing in a non-solvent for the polymer, the structure does not change anymore. It is therefore, preferred that liquid-liquid phase separation occurs before the structure is fixed, which can either be a result of crystallization of the polymer in solution of crystallization of the solvent.

This method advantageously provides porous scaffolds that can e.g. be used as body implants like meniscus implants, spinal disc implants, glenoid implants, etc. The scaffolds have a good porosity and a high interconnectivity, thereby enabling tissue ingrowth, a high (tear) strength and a high compression modulus to deal with the forces that the implant experiences.

Depending upon the kind of elastomer-solvent combination, providing a homogeneous solution of the elastomer in a solvent according to the invention may also include a heating of the solution of the elastomer in a solvent to a temperature above liquid-liquid phase separation.

Preferably, elastomers are used that are capable of crystallization in solution. Thus, preferably a method is used whereby T_{liq} is higher than T_{c,p}. If the elastomer does not crystallize in solution, the solution can be cooled till below the crystallization temperature of the solvent.

The interrelation between C_{B}, (C_{B} being the concentration of a particular elastomer in solution, for which the temperature at which liquid-liquid phase separation occurs (Tₗᵢq) is equal to the crystallization temperature of the polymer in solution (T_{c,p})) T_{liq}, T_{c,p} etc. for a solution of a particular polymer in a particular solvent is shown in FIG. 4 (phase diagram). In FIG. 4, a phase diagram of a polymer solution is shown. Such diagram is well known and is described in any polymer textbook on polymer solutions. The phase separation is represented by the binodal. For combinations of temperature and polymer concentrations under the diagram, phase separation occurs.

In addition, the phase diagram shows a melting curve indicated with T_{m,p}, representing the melting temperature of the polymer in solution at a certain polymer concentration. The corresponding crystallization curve is also shown and is indicated with T_{c,p}, representing the crystallization temperature of the polymer in solution at a certain polymer concentration. (The crystallization of a polymer in solution generally takes place 20-30° C. below the melting point of the polymer in solution).

The arrow in FIG. 4 correspond to'a cooling procedure. At higher temperature the polymer solution with a certain polymer concentration (Cₛₒₗ) is homogeneous. Upon cooling down, the temperature where the polymer solution starts to phase separate, T_{liq}, is reached.

When phase separation occurs the homogeneous solution separates into two liquid phases, a polymer rich phase and a polymer poor phase (together referred to as “polymer diluent” since formally the polymer solution no longer exists). The polymer poor phase contains almost no polymer. Upon further cooling down the concentration of the polymer in the polymer rich phase increases, while the percentage polymer poor phase of the total diluent increases. Thus, in the phase diagram, the concentration polymer in the polymer rich phase, is indicated for each temperature by the binodal. At temperature T_{c,p} the concentration of the polymer in the polymer rich phase has reached the value of C_{B}. Since T_{c,p} is the crystallization temperature of the polymer in solution the polymer crystallizes at this temperature, and prevents further phase separation when the temperature is lowered further below T_{c,p}. At this point the volume percentage polymer poor phase is 100×c/(a+c), and the percentage polymer rich phase is 100×a/(a+c).

According to the method, first a polymer mixture has to be made, which may include a heating step. The solution should have a concentration of the elastomer (polymer) between 0.4C_{B} and 0.9C_{B}, preferably between 0.4 C_{B} and 0.8 C_{B}. C_{B} is the concentration of a particular elastomer in solution, for which the temperature at which liquid-liquid phase separation occurs (T_{liq}) is equal to the crystallization temperature of the polymer in solution (T_{cp}).

If the concentration of the polymer solution that is cooled is between 0.4C_{B} and 0.9C_{B}, then the volume percentage of the polymer poor phase is 40-90% of the total volume. The percentage polymer poor phase is related to the pore structure of the final porous scaffold. After the polymer has crystallized and the structure is fixed, the solvent is removed in step d) of the process.

The space that used to be occupied by the polymer poor phase, has formed pores, after the solvent has been washed out of the scaffold.

The morphology of the porous structures of the invention is a combination of pores caused by leaching of the leaching material and liquid-liquid phase separation.

It has been found that if the concentration of the polymer is lower than 0.4 C_{B} or higher than 0.9 C_{B} results in either relatively worse mechanical properties and/or poorer interconnection of the pores of the scaffold.

After a homogeneous polymer solution is made, the polymer solution is homogeneously mixed with a pore forming material (particulate material). Suitable pore forming materials are for example saccharose, or a salt for example NaCl, KCl, CaCl₂, MgCl₂. The pore forming material can be sieved to specific sizes (30-1500 μm). It is preferred that the pore forming material does not dissolve in the solvent. For e.g. meniscus implants, the pore forming material may comprise particles with about 50-700 μm, for example about 100-360 μm.

For the method of the invention it is particularly preferred that the solution shows, upon cooling down, liquid-liquid phase separation before the polymer (or the solvent) crystallizes. Thus, liquid-liquid phase separation should occur at a temperature above the crystallization temperature (T_{cp}) of the elastomer.

Hence, an appropriate solvent-elastomer combination should be chosen. The conditions and the temperature at which liquid-liquid phase separation occurs can be manipulated by, for example, the addition of an appropriate amount of non-solvent to the solution, and/or by changing the molecular weight and composition of the polymer. When a non-solvent is added, liquid-liquid phase separation will occur at a higher temperature.

By choosing the appropriate conditions, the window in which liquid-liquid phase separation occurs can be influenced for a particular elastomer solution.

The melting point of the polymer as well as melting point of the polymer in solution can be determined by Differential Scanning calorimetry (DSC) which is a well known technique in Polymer Technology.

For any given polymer/solvent combination (including elastomer/solvent combinations) the temperature at which liquid-liquid phase separation occurs (T_{liq}) can be determined by light based techniques, for example light scattering and optical microscopy, methods known to the person skilled in the art or by modulated DSC (M. Reading, B. K. Hanhn, B. S. Crowe, U.S. Pat. No. 5,224,775). The characteristics of a certain polymer solution are reflected in its phase diagram and the melting curve and crystallization curve. The phase diagram is determined by determination of T_{liq} as a function of polymer concentration. The polymer/solvent combination may further comprise some non-solvent. By adding the non-solvent and by choosing the solvent, the person skilled in the art can tune the phase diagram such that for the chosen combination liquid-liquid phase separation occurs, upon cooling down, at a temperature (T_{liq}) that is higher than the crystallization temperature of either the polymer (T_{c,p}) or the solvent (T_{c,s}). Hence, in an embodiment, the invention is also directed to a method for making a porous scaffold, wherein the solvent of a) further comprises a non-solvent, e.g. wherein the non-solvent comprises a polar non-solvent. For example, this can be a method, wherein the solvent comprises 2-20 wt. % non-solvent, e.g. 2-15 wt %. This amount may depend on the solvent, non-solvent and polymer. In the invention, solvent may also comprise a number of solvents, and non-solvent may also comprise a number of non-solvents. When a solvent/non-solvent mixture is used, T_{c,s} describes the crystallization temperature of the solvent/non-solvent mixture. When combinations of polymers (polymers) would be used, T_{c,p} describes the crystallization temperature of the combination of polymers.

When phase diagrams are not known, the method of the invention may also include a determination of one ore more phase diagrams for the polymer/solvent combination (1a) as function of the type of solvent, (1b) as function of the type of solvent combinations and their respective amounts, and where applicable (2a) as function of the type of non-solvent, (2b) as function of the type of non-solvent combinations and their respective amounts. When one uses combinations of polymers, one may also determine phase diagrams (3) as function of the type of polymer combinations and their respective amounts. This can be done with techniques known by the person skilled in the art. Hereby, this person skilled in the art can choose those combinations of polymer/solvent or polymer/solvent/non-solvent that, according to the invention, for the chosen combination liquid-liquid phase separation occurs, upon cooling down, at a temperature (T_{liq}) that is higher than the crystallization temperature of either the polymer (T_{c,p}) or the solvent (T_{c,s}). Here, solvent and non-solvent may also comprise combinations of solvent and non-solvent, respectively. The person skilled in the art can also use both combinations of solvent and non-solvent, and when desired also combinations of polymers (e.g. polymers based on macrodiols with different molecular weights).

The polymer diluent should be cooled to a temperature below T_{c,p}. The cooling rate determines the rate at which liquid-liquid phase separation occurs. When liquid-liquid phase separation occurs, polymer poor domains are formed, within the continuous, polymer rich phase. The rate of cooling affects the rate of formation and the size of the polymer poor domains. It has been found that the size and distribution of the polymer poor domains determines the appearance of the micropores in the final porous scaffold. (The micropores also connect the macropores formed where the particulate material used to be.) Thus, by adjusting the cooling rate the size of the polymer poor domains can be influenced. Preferably the cooling rate is chosen in such a way that domains with a diameter over 30 μm are created when the final structure is fixed (for example, when the crystallization temperature of the polymer has been reached). Porous structures with porosities higher than 60% can be made, and e.g. scaffolds with a porosity of 70 or 80% could be obtained. Cooling to a temperature of about 20 or −18° C. gave good results.

When the domains are not large enough, the cooling rate has to be decreased. The amount of domains can be influenced by increasing the difference between T_{liq} and T_{c,p}, for example by adding a non-solvent.

Finally the mixture has to be cooled to below the T_{cp}. Crystallization of the polymer in solution prevents further phase separation and fixates the structure for the final porous scaffold.

After that the, solvent or solvent mixture and pore forming material has to be washed out at a temperature below the melting temperature of polymer diluent, Tₘ. A washing agent should be used in which the elastomer does not dissolve (non-solvent). Washing out the solvent and pore forming material can be done in several steps. In the first step the solvent is washed out and thus the washing agent has to be mixable with the solvent mixture. Suitable washing agents for solvents like DMSO, NMP, DMF and dioxane mixed with non-solvent like water, ethanol, or water and ethanol.

When polar non-solvents like diethyl ether, hexane are used, ethanol is a suitable washing agent. Water can still be a good washing agent but needs to be mixed with a certain amount of ethanol to ensure mixing of the non-solvent in the washing agents. When solvents like chloroform are used and for example ethanol, hexane or pentane are used as non-solvent, and a suitable washing agent is ethanol. In the second step the pore forming material is washed out. It is preferred that the pore forming agent is soluble in the washing agent but that the polymer does not dissolve in the washing agent (non-solvent for polymer). A suitable washing agent for washing out for example saccharose or NaCl, saccharose, or glucose is water. The solvent mixture and the pore forming mixture can also be washed out at once when they are both soluble in the washing agent.

The method for making porous scaffolds provided by the present invention is especially suitable to prepare porous scaffolds of the polyurethanes and polyurethane ureas (made according to the method) of the invention. Suitable solvents for polyurethanes and polyurethane ureas are DMSO, DMF, NMP, cresol, 1,4-dioxane, chloroform. In another embodiment, the invention is directed to a method for making porous scaffolds, wherein the solvent for polyurethanes or polyurethane ureas are selected from the group consisting of DMSO, DMF, NMP, cresol, and chloroform.

It was found that certain combinations of washing agents prevented skin formation and resulted in an open pore structure at the surface, which further improves the porous structure. In this case the skin does not have to be removed before implantation, which improves the method for making a porous scaffold. In a preferred embodiment of the method, washing is performed in successively water/ethanol 80/20, ethanol/water 95/5, and diethyl ether or hexane or pentane. It was found that, for porous scaffolds made on the basis of poly(ε-caprolactone) based polyurethanes, skin formation could be prevented when washing was performed in successively water/ethanol 80/20, ethanol/water 95/5, and diethyl ether or hexane or pentane.

In particularly preferred embodiments, a porous scaffold is prepared from a polyurethane polymer according to the invention, by the steps (a) through (d) below:

(a) Preparing a homogeneous solution of the polyurethane, preferably of about 30% to about 45% (v/v), more preferably of about 36% (v/v) of the polyurethane, in an appropriate solvent (for example, NMP, cresol, dimethyl acetamide or DMSO, preferably DMSO). The polyurethane and the solvent are stirred for a period of time in which the molecular weight of the polymer was observed to increase. It is preferable that the polymer have a high viscosity while remaining soluble in the solvent. However it is preferable that the viscosity not increase to the point that the non-solvent can not be thoroughly mixed into the polymer solution. The polymer solution is preferably stirred at an elevated temperature of about 60° C. to about 90° C., preferably about 80° C., for about 1 to 6 hours, and more preferably from about 2-5 hours.

(b) A non-solvent, preferably water or a C1-6 alkyl alcohol, in an amount of 5% to about 30% (v/v), preferably about 5% to about 20%, more preferably about 5% to about 10%, is added to the polymer solution and the resulting mixture is homogenized for about 10-30 minutes. It is preferred that the water is added quickly and that the resulting mixture is not allowed to stir for too long. Without being limited by theory, it is believed that, due to the presence of unreacted NCO groups that react with the water, the water is acting as a chain extender. The unreacted NCO groups may react with water to form amine groups, which have a higher reactivity with NCO groups than OH group. Upon addition of water, urea bonds are thus formed (NCO with amine reaction) which contribute to the strength of the polymer.

(c) A pore forming material is added to the homogeneous solution that is not soluble in the solvent to form a homogeneous mixture of the polymer, the solvent and the pore forming material. The pore forming material may be added to a concentration of about 100% to about 400% (w/v) (weight of pore forming material and volume of polymer solution (with non-solvent)), preferably to about 200% to about 300% (w/v), and more preferably about 270% (w/v). The pore forming material can be a salt for example NaCl, KCl, CaCl₂, MgCl₂. The pore forming material may be heated to about 50° C. to about 140° C., preferably to about 80° C. to about 90° C.

(d) The viscous mixture is poured into mold and cooled at about −100° C. to about 30° C., preferably at about 0° C. to about 20° C., and more preferably at about −18° C.

(e) The resulting article is washed with a non-solvent, wherein the polymer is insoluble, but wherein the particulate material can be dissolved.

In another embodiment the present invention provides a biocompatable foam prepared according to the methods of the present invention.

In another embodiment of the present invention there is provided a foam comprising polyurethane having average molecular weight of about 110 kg/mol to about 240 kg/mol, a compression module of about 50 kPa to about 1500 kPa, and a tear strength of greater than 3 N/mm. Preferably, the foam has a flexibility of 100% or more, more preferably of 100% to about 500%, even more preferably of about 300% to about 400%. Preferably, the density of the foam is from about 0.1 to about 0.4 g/cm³, more preferably about 0.22±0.04 g/cm³.

In one embodiment, the polyurethane polymer in the foam of the present invention has an average molecular weight of about 110 kg/mol to about 240 kg/mol. In another embodiment the foam has a molecular weight of 120 kg/mol to about 240 kg/mol. In another embodiment the foam has a molecular weight of 140 kg/mol to about 240 kg/mol.

In one embodiment, the foam of the present invention has a compression modulus between about 50 kPa to about 1500 kPa. In another embodiment, the foam has a compression modulus between about 100 kPa to about 1500 kPa. In another embodiment, the foam has a compression modulus between about 200 kPa to about 1200 kPa. In another embodiment, the foam has a compression modulus between about 50 kPa to about 200 kPa. In another embodiment, the foam has a compression modulus between about 200 kPa to about 400 kPa. In another embodiment, the foam has a compression modulus between about 400 kPa to about 600 kPa. In another embodiment, the foam has a compression modulus between about 600 kPa to about 800 kPa. In another embodiment, the foam has a compression modulus between about 800 kPa to about 1000 kPa. In another embodiment, the foam has a compression modulus between about 1000 kPa to about 1200 kPa. In another embodiment, the foam has a compression modulus between about 1200 kPa to about 1500 kPa.

In one embodiment, the foam of the present invention has a tear strength of about 3 N/mm or greater, preferably 3 to 25 N/mm.

In one embodiment, the foam of the present invention has a flexibility (strain at break) of about 100% or higher, preferably from 100% to about 600%, more preferably from about 300% to about 500%.

In one embodiment, the foam of the present invention has a density of about 0.1 to about 0.4 g/cm³. In a preferred embodiment the density is 0.22±0.04 g/cm³.

All references referred to herein are incorporated in their entirety. U.S. patent application publication number 20070015894 is incorporated herein in its entirety.

Having described the invention with reference to certain preferred embodiments, other embodiments will become apparent to one skilled in the art from consideration of the specification. The invention is further defined by reference to the following examples describing in detail the synthesis of the polyurethane and biocompatable foams made thereof, as well as biocomatable medical implants. It will be apparent to those skilled in the art that many modifications, both to materials and methods, may be practiced without departing from the scope of the invention

### EXAMPLES

### Example 1

### Polyurethane Synthesis

All steps in the synthesis of the polyurethane were performed under Argon atmosphere. 13.94 g (0.1547 mol) 1,4-butanediol (Acros, distilled from molsieves) was added to 233.46 g (2.0453 mol) ε-caprolactone (Acros, distilled from CaH₂). This mixture was polymerized to a macrodiol at 150° C. for at least 17 days, and the percentage of unreacted ε-caprolactone was checked with ¹H NMR. The reaction should be run until it is complete, which means that the caprolactone peak is hardly visible and the percentage of caprolactone remaining is below 0.2%. A typical reaction time is 21 days.

120.40 g (0.07533 mol) of the macrodiol was reacted with 139.41 g (0.99478 mol) 1,4-butanediisocyanate (distilled under reduced pressure) for 5 hours at 80° C. to obtain the macrodiisocyanate. The surplus diisocyanate was distilled off at reduced pressure of <0.003 mbar at 74° C. for 29 hours and 20 minutes. The amount of butanediisocyanate that had reacted with the macrodiol and could not be distilled off was 21.27 g (0.1518 mol), and the theoretical amount of BDI was 21.11 gram (0.15066 mol, 2× mol macrodiol). It is preferred that with this pressure, the amount of BDI that remains and cannot be distilled off is in the range of −5% to +5%.

The amount of BDO that has to be added is calculated from the amount of macrodiol used. It is preferred to be in the range of 1-9% excess of BDO, i.e. 1.00 mol macrodiol: 1.01-1.09 mol BDO. The BDO range is preferred because at a lower excess we get efficient crosslinking. At higher BDO excesses, although the same molecular weight for the bulk polymer results, the molecular weight does not increase sufficiently in the foam process because the stoichiometry is highly disturbed.

The macrodiisocyanate was reacted with 6.98 g (0.07745 mol) 1,4-butanediol at 90° C. (range 85-95) for at least 21 hours.

### Example 2

### Determination of the Molecular Weight of the Bulk Polyurethane

The molecular weight of the polyurethane was determined using gel permeation chromatography (GPC) (Shimadzu T030845) with polystyrene standards and using 0.01 M LiBr in DMF with a flow rate of 1 ml/mm. The Mn was 92.000 (range 80-100 kD) and the average Mw equaled 153000 g/mol giving a Mn/Mw range of 1.6 to 2.1

### Example 3

### Foam Formation

19.37 g polyurethane obtained in Example 1 was dissolved in 214.86 g dimethylenesulfoxide DMSO (DMSO distilled from CaH₂) for about 2.5 to about 3.25 hours at 80° C. This dissolving process further increases the molecular weight.

After dissolution, 13.43 g pyrogen free water was added quickly and the solution was homogenized for 15 minutes (range 10-30 minutes).

20.05 g of the polymer solution was mixed with 221.29 g NaCl that was sieved over 150 and 355 micrometer. The NaCl was preheated to 130° C. to prevent gellation of the polymer solution during mixing. The viscous mass was poured into a mould and cooled at −18° C. followed by washed with a non-solvent to remove solvents and NaCl.

### Example 4

### Preparing Polyurethane and Foam wherein the Remaining Unreacted Lactone is 0.8%

Polyurethane synthesis was performed with a macrodiol where the amount of caprolactone remaining was 0.8% and in which the amount of BDI that could not be distilled off was identical to the theoretical amount of BDI. The amount of BDO added was calculated in such a way that stoichiometric amounts of OH-groups and isocyanate groups were used (mol BDI−mol macrodiol)×90.122, applying a slight excess of 1.5%. In this case the viscosity of the polymer solution in the foam forming process became too high to be processable.

### Example 5

### Determination of Molecular Weight of the Foam

The molecular weight was determined using GPC (Shimadzu T030845) with polystyrene standards and using 0.01 M LiBr in DMF with a flow rate of 1 ml/mm. The Mn was 147 kg/mol (range 120-250 kg/mol), with a Mw of 310 kg/mol (Dispersity range 2.0-3.0).

### Example 6

### Tear Strength and Flexibility of the Foam

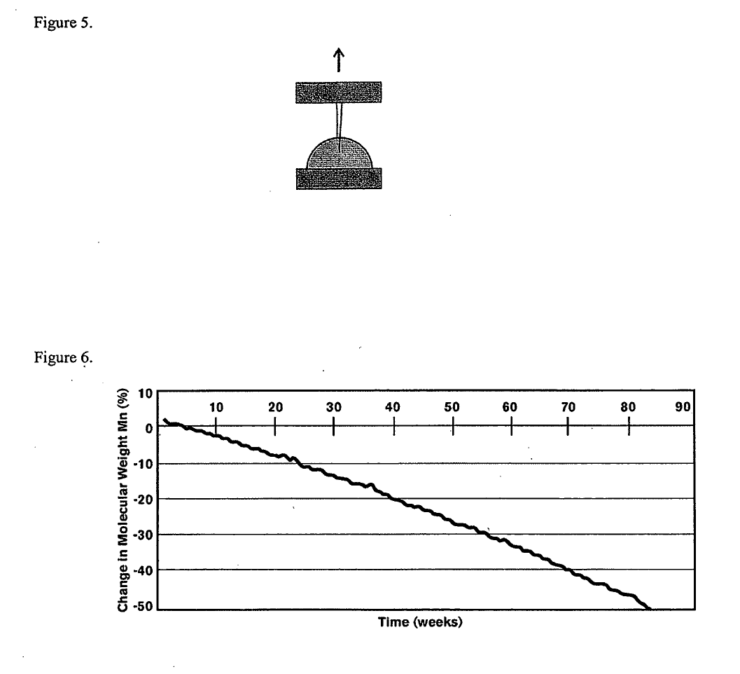

Tests were performed on circular samples with a thickness of about 8 mm. A 2-0 suture was positioned at 3 mm from the edge of the sample. FIG. 5 shows how the test sample with suture are placed in the clamps of the tensile tester (Instron 3342). The cross head speed was 10 mm/min. The tear strength was calculated as follows: the maximal force (N) is divided by the thickness of the test sample. The tear strength was at least 3.0 N/mm.

The flexibility was calculated as follows: the displacement at break divided by the distance of the suture to the edge of the implant material (being defined as 3 mm in this test method)*100%.

### Example 7

### Density of the Foam

Tests were performed on circular samples with a thickness of about 8 mm. The dimensions of the sample were determined using a caliper and the volume (cm³) calculated. The sample was weighed using an analytical balance and the density (g/cm³) was calculated from the mass (g) and the volume (cm³) of the material.

### Example 8

### Degradation of the Foam

It is expected that in vivo degradation takes place during a time period of 4-6 years. In FIG. 6 the changes in molecular weight during in-vitro degradation at 37° C. in phosphate buffer is shown. After 1.5 years the molecular weight has decreased to 50% of its original molecular weight.

### Example 9

### Cytotoxicity of the Implant

A segment of an implant of the present invention was extracted and the extract was brought into contact with cells. The lysis of cells (cell death), the inhibition of cell growth and other effects on cells caused by the extract were determined. The implant passed and there was no evidence of cell lysis.

### Example 10

### Sensitation on Implant

The implant of the present invention was extracted in 0.9% NaCl and sesame oil. Induction I: A range of concentrations were injected intradermally. The degree of allergic reaction (erythema) was determined after 24 hours at the injection site. Induction II: After seven days the same areas used during induction I, were treated with a Sodium Lauryl Sulfate solution to provoke a moderate inflammatory reaction. After 24 hours, patches soaked with 0.9% NaCl or sesame oil extracts or control were applied and maintained for 48 hours. The degree of allergic reaction was then assessed. The implant passed and there was no sensitization observed.

### Example 11

### Intracutaneous Irritation on Implant

Rabbits received intracutaneous route injections of 0.9% NaCl extract, sesame oil extract and controls. The sites were examined at 24, 48 and 72 hours after injection for gross evidence of tissue reaction, such as erythema, edema and necrosis. The implant passed, there was no irritation observed.

### Example 12

### Acute Systemic Toxicity of Implant

Mice were injected, by either intravenous route for the 0.9% NaCl extract or the intraperitoneal route for the sesame oil extract (and controls). The animals were observed immediately and at 4, 24, 48 and 72 hours after systemic injection. The implant passed, there were no adverse symptoms observed.

### Example 13

### Genotoxicity on Implant: Bacterial Reverse Mutation.

The test was performed to evaluate the mutagenic potential of the Actifit™ implant. Bacteria were exposed to Actifit™ implant extracts in 0.9% NaCl and in Ethanol 96%. Mutation was determined after incubation. The implant passed, there were no toxic effects observed.

### Example 14

### Genotoxicity on Implant: Chromosomal Aberration Test in Mammalian Cells in-vitro

The test was performed to evaluate the potential clastogenic properties on chromosomes of human lymphocytes. Human lymphocyte cultures were exposed to the implant extracted in 0.9% NaCl. A preliminiary study was performed without the metabolic activiation system in order to determine the possible toxicity of five concentrations of the extract. The highest non-toxic concentration (40 μL of extract/mL of culture medium) was tested. After the contact period, the cultures were treated in order to perform chromosome preparation. The detection of aberrations was performed by observing chromosomes. The implant passed, no effects were observed.

### Example 15

### Genotoxicity on Implant: Mouse Bone Marrow Micronucleus

The test was performed to evaluate the mutagenic potency after intraperitoneal injections into mice of the implant extracts. The test and the negative control groups received an intraperitoneal injection for two days (day one and two), whereas the positive control mice received a single intraperitoneal injection of cyclophosphamide on day two. Mice were observed immediately after injection for general health and any adverse reactions. On day 3, all mice were weighed and terminated. The femurs were excised, the bone marrow was extracted and duplicate smear preparations were performed on each one. Mammalian cells were exposed to the implant extracted in 0.9% NaCl and in Ethanol 96%. Mutation was determined after incubation. The implant passed, there were no mutagenic/toxic effects observed.

### Example 16

### Combined Subchronic Toxicity Study & Local Tolerance Study on Implant Material and Accelerated Implant (Polyurethane Segments)

Accelerated implant degradation products were made as follows. Powdered implant material was subjected to 9M HCl for 3 days. The remaining material (the hard segments) was isolated through several washing steps, centrifuged and dried. Further purification was performed by washing with pyrogen free water and finally washing with 96% ethanol (pharmaceutical grade). After drying in a vacuum oven the hard segments were powdered with a motor and pestle. Malditov- and ¹H-NMR analysis showed that soft segment degradation was effective and mainly the hard segments were leftover. SEM analysis was too big and not representative of the actual size of the hard segments (the small particles clustered together as a result of the washing and drying process). Therefore a sonication procedure was performed in a 0.9% saline solution, which yielded a milky dispersion in which upon standing no sediments were seen. SEM analysis revealed that 98% of the particles in the milky dispersion were representative for the size of the hard segments that would be expected after in vivo degradation of the soft segments (70 to 130 nm).

The milky dispersion (0.4 mL) was injected into the dorsal subcutaneous space of rats and the site was marked by ink tattoo to identify the injection site at necropsy.

In addition, disks of the implant material weighing 90±2 mg with a thickness of 2.5±1.1mm were sterilized and implanted into one side of the back of 10 male and 10 female rats (on the other side of the back 2 mL of 0.9% NaCl was injected as a control). One control group received one high density polyethelylene disk.

The rats were observed immediately after implant and everyday there after to detect mortality or morbity and any abnormal clinical signs. Body weight and food intake was recorded weekly. At the end of the implantation interval (13 weeks), blood samples were collected for hematology and clinical chemistry and the rats were subjected to submacroscopic necropsy and microscopic examination of selected organs and implanted sites.

No mortality or clinical signs that could be related to a toxic effect of the implants were observed. The degraded implant material (hard segments) was taken up by macrophages.

### Example 17

### Combined Chronic Toxicity & Local Tolerance Study on Implant Material and Accelerated Implant (Polyurethane Segments), 26 Weeks

One group of rats was implanted with the implant of the present invention. One group were injected with the accelerated degraded implant (polyurethane segment agglomerates of sizes 70-130 nm) as described above. One control group of 10 male and 10 female rats received one high density polyethelylene disc. The rats were observed immediately after implantation, then everyday to detect mortality or morbidity and any abnormal clinical signs. Body weight and food intake were recorded once a week. At the end of the implantation interval (26 weeks), blood samples were collected for hematology and clinical chemistry and rats were subjected to a macroscopic necropsy and microscopic examination of selected organs and implanted sites. The implant passed, there were no clinical signs of toxic effect. The degraded implant material (hard segments) underwent phagocytosis by macrophages.

### Example 18

### Analysis of Wear Debris

The stress that the knee is under is very high and it can be expected that particles of the implant will be separated from the implant. A wear debris test for implants of the present invention was performed in the rabbit knee model to show the safety of the particle debris. This test was performed to evaluate the local tolerance of wear debris resulting from the implant, four weeks following an intra-articular injection in the rabbit knee.

Polyurethane foam of the present invention was cut into pieces of 1 to 2 cm³. Six to eight pieces of foam were placed into a blender (Janke&Kunkel IKA Labortechnik analysemiihle type A10) and cooled with liquid nitrogen in the blender. When the liquid nitrogen was evaporated, the foam pieces were blended for 30 seconds. The foam particles that stuck to the cover were collected in one batch and dried at 40° C. in a vacuum stove. The particles were sterilized in preparation for the in vivo test.

Size distribution of the foam particles was determined using a light microscope and later using a scanning electron microscope. Both microscopy methods determined that 95% of the foam particles had an average particle size of 50-500 μm.

Rabbits were injected in the left knee joint with 0.2 mL of the test suspension (wear debris at the dose of 23 mg/mL in a mixture of isopropanol and distilled water (30:70 v/v) while the contralateral knee received 0.2mL of the suspension alone. About 5 mg of particles (˜800) in the size range of 50-500 μm were injected. The mean weight of the rabbits was 3.5 kg, which corresponds with 65 mg for a 50 kg person and it is about 10% of a scaffold. Animals were observed once daily for any clinical abnormality. Four weeks post-injection all animals were terminated. Each knee was dissected, opened and examined and a gross examination of each knee compartment was performed. For each site, the synovial membrane was collected for histological analysis. There were no signs of pain or swelling and there was no synovial fluid accumulation. In summary there were no differences between the test and control knees.

### Example 19

### Implantation in Sheep

Few options exist to repair damaged knee menisci, oftentimes leading to partial or full meniscectomy. However removal of meniscal tissue can result in joint degeneration (Scheller et al. Arthroscopy 17:946-52 (2001)). Implants of the present invention were studied to assess the long-term performance of the scaffold after implantation in a partial meniscectomy ovine model.

Fifty skeletally mature sheep were subjected to unilateral partial meniscectomy. In 30 animals the partial meniscectomy was replaced by a scaffold. The primary outcome measured was histological grading of cartilage damage on the tibial plateau. Secondary outcomes were: (i) general appearance of the knee, (ii) frictional coefficient of the scaffold as a function of time, (iii) evidence of tissue ingrowth into the scaffold, and (iv) load transfer characteristics as a function of time.

A three months post implantation, 10 scaffold implanted knees and 10 partly meniscectomized knees were analyzed. By three months the scaffold was populated with cells surrounded by extracellular matrix that was integrated with the native meniscus. Tissue ingrowth also occurred into the unfilled partial meniscectomy, suggesting that the ovine model has some innate capacity to heal partial meniscal defects. Damage to the tibial plateau, was slight, and damaged areas tended to be located close to the middle of the plateau in both the scaffold and non-scaffold implanted groups, while collagen orientation and proteoglycan content in the submeniscal zones was preserved. This finding was confirmed by histologically and radiologically.

The fact that cartilage under the scaffold was not damaged suggests that the comparatively high frictional characteristics of the scaffold at time zero did not lead to cartilage degeneration. Of note, the frictional characteristics of the scaffold were significantly lower at the 3 month sacrifice time point. These changes are likely closely linked to cell infiltration and matrix deposition into the scaffold seen by histology.

The blinded grading of the histological sections taken from the tibial plateau revealed no significant difference between partly meniscectomized and scaffold implanted groups in terms of cartilage surface fibrillation. However, hypercellularity, tide mark disruption, and reactivity of bone tended towards higher scores on the partly meniscectomized knees. These data indicate that at three months, early joint degeneration was more prevalent in the partly meniscectomized knees when compared to the scaffold implanted knees, which suggests that some protection is being provided by the scaffold compared to the partial meniscectomy without subsequent scaffold implantation. The ovine model represents a severe test because the animals and their knee joints are not immobilized.

### Example 20

### Human Implantation

Following surgical implantation, the device is intended to support tissue ingrowth and meniscal regeneration, and therefore protect against chondral joint damage. The device has been investigated for safety and performance in a prospective, interventional study. The integration and vascularization of the implanted device has been assessed using anatomic and dynamic magnetic resonance imaging (MRI) techniques. Pain and quality of life were assessed using a visual analog scale (VAS), the Knee Osteoarthritis Outcome Score (KOOS) and the International Knee Documentation Committee (IKDC) score.

Conventional post-operative MRI has been shown to correlate well with arthroscopy, and clinical and histologic examinations for the assessment of meniscal allograft placement, as well as articular cartilage wear (Potter H G, et al. (2006) Radiol 198:509-514).

Dynamic MRI involves the measurement of gadolinium influx into a tissue immediately after injection in order to assess vascularization, capillary permeability, perfusion and volume of the interstitial fluid. Influx is represented as a time intensity curve (TIC), which permits an evaluation of the healing process after surgery.

Methods. A single-arm, multi-center, interventional clinical study was performed. Contrast enhanced MRI using intravenous gadolinium was performed at 1 week, 3 and 12 months post surgery. In addition, VAS, KOOS and IKDC at baseline, 1 week, 3, 6 and 12 months post surgery.

Key inclusion/exclusion criteria were as follows:
Skeletally mature subjects aged 16-50 years with irreparable medial or lateral meniscal tears or partial meniscus loss, but with intact rim.
Stable knee joint or scheduled for knee joint stabilization procedure within 12 weeks.
ICRS classification Grade I or II.
No significant malalignment, additional bone defects or advanced osteoarthritis of the knee.

Neovascularization in the peripheral zone of the implanted meniscus was assessed by tracking enhancement of signal intensity on MRI in the Region Of Interest (ROI) following intravenous injection of gadolinium. The peripheral zone encompasses the peripheral half of the scaffold meniscus, representing the most important area for assessment of integration. Influx of gadolinium causes a marked increase in the signal intensity (signal enhancement) of a tissue, and the rate of signal enhancement is predominantly determined by vascularization, but also by the perfusion rate and capillary permeability [Tokuda O, et al. (2005) Skeletal Radiol 34:632-638, Verstraete K L, et al. (1994) Radiol 192:835-43]. Thus, a TIC can be generated and semi-quantitative parameters (slope gradient, absolute and relative enhancement, the time to onset of signal enhancement) are used to analyze ingrowth of blood vessels into the scaffold device.

Interim Results

Baseline characteristics

| N = 39 | | |
|---|---|---|
| Age | | |
| Mean ± SD | 32.1 ± 9.0 | |
| Sex | | |
| Male | 30 | (76.9) |
| Female | 9 | (23.1) |
| Defect characteristics | | |
| Medial meniscus (n [%]) | 31 | (79%) |
| Lateral meniscus (n [%]) | 8 | (21%) |

| | |
|---|---|
| Longitudinal length (mean ± SD; n = 38) | 47.8 ± 10.0 |

Dynamic MRI.

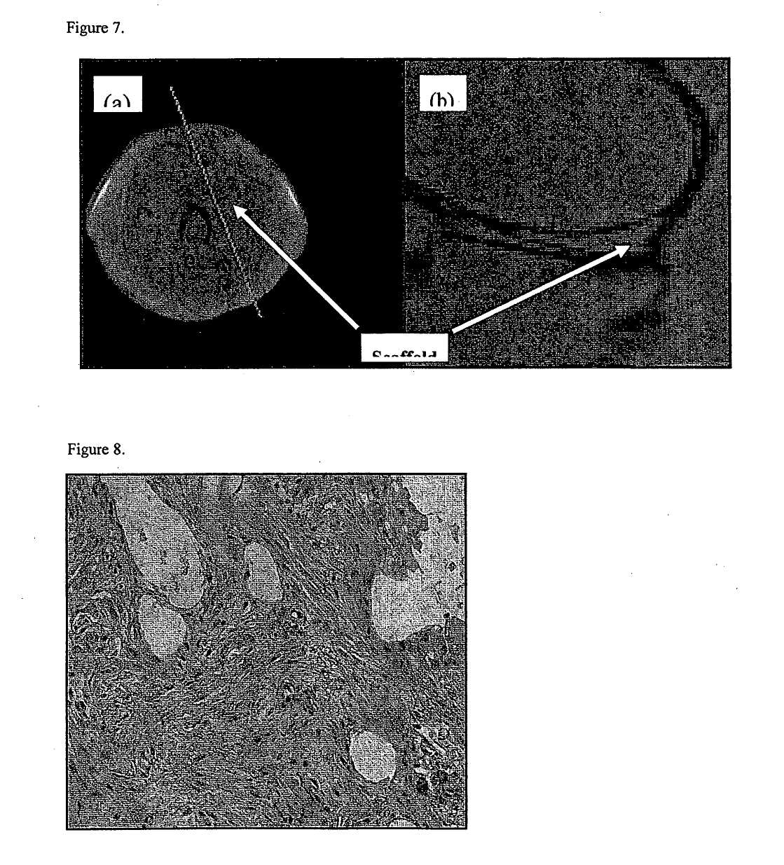

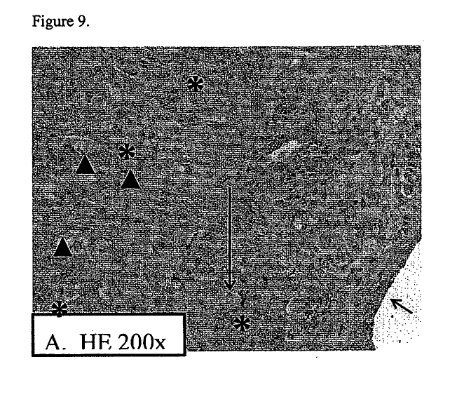

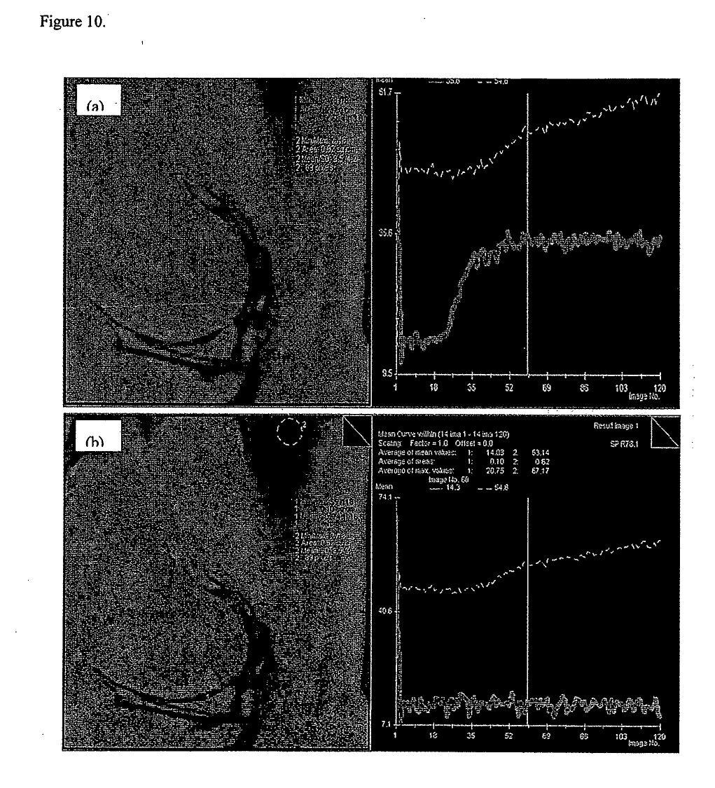

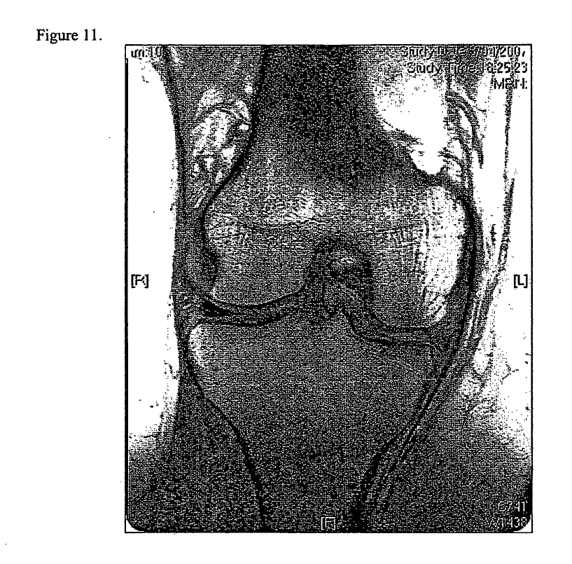

MRI data are available for 36 subjects at 3 months and 4 subjects at 12 months. See FIG. 7 for correct positioning of MR image. Of the 36 subjects with data at 3 months, dynamic MRI series were missing for 1 subject, and 2 subjects had dynamic MRI series performed in the wrong area. In 81.8% (27/33) of subjects with valid dynamic MRI data, vascularization (relative enhancement≧0.1) was evident in the ROI at 3 months. Vascularization was evident in 3 of 4 subjects in the ROI on dynamic MRI series at 12 months. Loss of meniscal substance in the ROI is the probable explanation for a lack of signal enhancement in two subjects at 3 months and one subject at 12 months.

Preliminary Efficacy.

Mean change (95% confidence intervals) from baseline in VAS, KOOS and IKDC scores at 3 months and 6 months:

| | 3 Months | | 6 Months | |
|---|---|---|---|---|
| VAS | −17.5 | (−28.1, −7.0)** | −25.8 | (−41.4, −10.3)** |
| IKDC | 8.2 | (0.2, 16.2)* | 18.8 | (8.6, 29.1)** |
| KOOS | | | | |
| Symptoms | 6.2 | (−4.0, 16.3) | 13.7 | (−1.7, 29.0) |
| Pain | 12.5 | (3.5, 21.6)* | 17.5 | (4.6, 30.3)* |
| Daily living | 9.8 | (19., 17.7)* | 13.8 | (4.9, 22.8)** |
| Sport/recreation | Not available | | 22.1 | (6.1, 38.1)* |
| Quality of life | 9.1 | (−3.1, 21.4) | 17.7 | (5.1, 30.4)** |

Statistically significant change from baseline: *P ≦ 0.05 or **P ≦ 0.005

Safety. Two serious adverse events were reported, neither of which was related to the implanted device. No risks, other than the generally acknowledged risks associated with surgery, have been identified to date.

Summary and Conclusions. No serious device or procedure related adverse events were observed. Vascular ingrowth was demonstrated in >80% (27/33) of the subjects. There was full integration and ingrowth after 2 months following implantation. Histology at 9 and 12 months revealed fibrochondrocytes (meniscus cells) present in the scaffold.

In addition, the subjects reported a significant decrease in pain and a Significant increase in daily living, sport/recreation and quality of life. Based on these interim results the investigated scaffold meniscus implant provides a safe and viable treatment option for irreparable meniscus tears.

1. A process preparing a polyurethane comprising:
(a) reacting a diol, with an oxygen containing compound that can form a macrodiol by ring-opening polymerization, to provide a macrodiol, wherein the reaction is carried out to completion;
(b) treating the macrodiol with a diisocyanate, to obtain a macrodiisocyanate, wherein the unreacted diisocyanate is removed under a pressure of less than about 0.01 mbar; and
(c) reacting the macrodiisocyanate with a diol chain extender, wherein the molar ratio of macrodiisocyanate:diol is 1.00:1.01 to 1.00:1.09.

2. The process of claim 1, wherein the diol is 1,4-butanediol.

3. The process of claim 1, wherein the oxygen containing compound is a lactone.

4. The process of claim 3, wherein the lactone is ε-caprolactone.

5. The process of claim 1, wherein the unreacted remaining oxygen containing compound that can form a macrodiol by ring-opening polymerization is less than 0.5% by mole equivalents of the total amount of the oxygen containing compound.

6. The process of claim 5, wherein the unreacted containing oxygen compound is less than about 0.2% by mole equivalents by mole equivalents of the total amount of the oxygen containing compound.

7. The process of claim 1, wherein the diisocyanate is butanediiosyanate.

8. The process of any of claim 1, wherein the remaining amount of unreacted diisocyanate is between −5% to 5% by mole equivalent of the calculated required amount of diisocyanate in the reaction.

9. The process of claim 8, wherein the remaining amount of unreacted diisocyanate is between −2% and 2% by mole equivalents.

10. The process of claim 1, wherein the diol chain extender is a C₁-C₁₀ alkyl diol.

11. The process of claim 11, wherein the C₁-C₁₀ alkyl diol is 1,4-butanediol.

12. The process of claim 1, wherein the molar ratio of macrodiisocyanate:diol is 1.00:1.01 to 1.00:1.03.

13. A polyurethane prepared according to the process as in claim 1.

14. A biocompatible foam comprising polyurethane having average molecular weight of about 110 kg/mol to about 240 kg/mol, a compression module of about 50 kPa and 1500 kPa, and a tear strength of greater than 3 N/mm.

15. The biocompatible foam of claim 14, wherein the average molecular weight is from 140 kg/mol to about 240 kg/mol.

16. The biocompatible foam of claim 14, wherein the compression module is from about 250 kPa to about 600 kPa.

17. The biocompatible foam of claim 16, wherein the compression module is from about 250 kPa to about 400 kPa.

18. The biocompatible foam of claim 14, wherein the tear strength is 3 N/mm to 25 N/mm.

19. The biocompatible foam of claim 14, wherein the foam has a flexibility of 100% or more.

20. The biocompatible foam of claim 19, wherein the foam has a flexibility of about 300% to about 500%.

21. The biocompatible foam of claim 14, wherein the density of the foam is from about 0.1 to about 0.4 g/cm³.

22. The biocompatible foam of claim 21, wherein the density is 0.22±0.04 g/cm³.

23. A process of preparing a foam comprising:
(a) preparing a mixture of about 20% to about 50% (w/v) of the polyurethane as prepared according to claim 1 in an appropriate solvent to obtain a solution;
(b) combining the solution with a non-solvent to obtain a reaction mixture;
(c) adding a pore forming material not soluble in the solvent to obtain a viscous mixture;
(d) pouring the viscous mixture into a mold and/or cooling, in any order to obtain a molded material; and
(e) washing the molded material with a non-solvent wherein the polyurethane polymer is insoluble but wherein the pore forming material can be dissolved to obtain a foam.

24. The process of claim 23 wherein the mixture in step (a) has a concentration of about 30% to about 45% (w/v) of the polyurethane.

25. The process of claim 23, wherein the solvent in step (a) is selected from DMSO, DMF, chloroform, 1,4-dioxane, NMP, m-cresol, or dimethyl acetamide.

26. The process of claim 25, wherein the solvent is DMSO

27. The process of claim 23, wherein the non-solvent is water.

28. The process of claim 23, wherein the amount of non-solvent added to the solution is in an amount from 5% to 30% (v/v).

29. The process of claim 28, wherein the amount of non-solvent added to the solution is in an amount from 5% to 10% (v/v).

30. The process of claim 23, wherein the pore forming material is a salt.

31. The process of claim 30, wherein the salt is an alkali metal or alkaline earth metal salt.

32. The process of claim 31, wherein the salt is NaCl.

33. The process of claim 23, wherein the foam is a biocompatible foam.

34. A polyurethane foam prepared according to the process of claim 23.

35. The polyurethane foam of claim 34, wherein the foam is biocompatible.

36. The polyurethane foam of claim 34, wherein the foam has an average molecular weight of about 110 kg/mol to about 240 kg/mol.

37. The polyurethane foam of claim 34, wherein the foam has a compression modulus of 50 kPa to 1500 kPa.

38. The polyurethane foam of claim 34, wherein the foam has a tear strength of greater than 3 N/mm.

39. A biocompatible medical implant prepared from a polyurethane foam selected from the group consisting of the polyurethane foam of claim 14 and the polyurethane foam of claim 34.

40. The biocompatible medical implant of claim 39, wherein the biocompatible medical implant degrades after implantation and the degradation products are biocompatible.

41. The biocompatible medical implant of claim 40, wherein the medical device is a meniscal implant, a glenoid implant, or a glenoid labrum implant.
